(19) United States
(12) Patent Application Publication
(10) Pub. No.: US 2008/0253515 A1
(43) Pub. Date: Oct. 16, 2008

(54) Apparatus and Method for Correction of Extension of X-Ray Projections

(75) Inventors: Matthias Bertram, Koein (DE); Jens Wiegert, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/815,016

(22) PCT Filed: Jan. 31, 2006
(86) PCT No.: PCT/IB2006/050329

§ 371 Date: Jul. 30, 2007

(30) Foreign Application Priority Data
Feb. 1, 2005 (EP) 05100666.6

(51) Int. Cl. G01N 23/204

(52) U.S. Cl. 378/62

(57) ABSTRACT

The present invention relates to an apparatus for iterative scatter correction of a data set of x-ray projections (10) of an object (1) for generation of a reconstruction image of said object. In particular for correction of artifacts caused by scatter or a truncation of x-ray projections, an apparatus is proposed, which requires less computational effort and which thus allows a correction in real-time, comprising: a model estimation unit (41) for estimating model parameters of an object model for said object by an iterative optimization of a deviation of forward projections, calculated by use of said object model and the geometry parameters for said x-ray projections, from the corresponding x-ray projections, —a scatter estimation unit (42) for estimating the amount of scatter present in said x-ray projections by use of said object model, and a correction unit (43) for correcting said x-ray projections by subtracting the estimated amount of scatter from said x-ray projections for determining an optimized object model using said corrected x-ray projections, said optimized object model being used in another iteration of said scatter correction, said scatter correction being iteratively carried out until a predetermined stop criterion has been reached. Further, corresponding apparatus for extension of truncated projections and a reconstruction apparatus is proposed.

The present invention relates to an apparatus and a corresponding method for iterative scatter correction of a data set of x-ray projections of an object for generation of a reconstruction image of said object. Further, the present invention relates to an apparatus and a corresponding method for extension of truncated x-ray projections of a data set of x-ray projections of an object for generation of a reconstruction image of said object. Still further, the present invention relates to an apparatus and a corresponding method for generating a reconstruction image from a data set of x-ray projections of an object. Finally, the invention relates to a computer program for implementing said methods on a computer.

Scattered radiation constitutes one of the main problems in cone-beam computed tomography. Especially for system geometries with large cone angle and therefore a large irradiated area, such as C-arm based volume imaging, scattered radiation produces a significant, spatially slowly varying background that is added to the desired detected signal. As a consequence, reconstructed volumes suffer from cupping and streak artifacts or, more generally, from artifacts causing slowly (locally) varying inhomogenities due to scatter, impeding the reporting of absolute Hounsfield units.

Mechanical anti-scatter grids have been designed to prevent detection of scattered radiation, but they have been shown to be ineffective for typical system geometries for volume imaging. Therefore, different algorithms for a posteriori software-based scatter compensation have been proposed (e.g. in Maher K. P., Malone J. F., “Computerized scatter correction in diagnostic radiology”, Contemporary Physics, vol. 38, no. 2, pp. 131-148, 1997) or are currently developed. However, though such methods have the potential to accurately estimate the shape of the spatial distribution of scatter within the projected views, accurate quantitative scatter estimation is difficult to achieve. As a consequence, the absolute local amount of scatter in the projected views is often under- or overestimated, leading to suboptimal reconstruction results.

There are other sources of artifacts in an x-ray projection that also cause spatially slowly varying inhomogenities in a reconstruction image which are, for instance, an incomplete data set used for the reconstruction due to the use of a detector which is smaller than the object of interest. It will then be desired to complete the data set to avoid the appearance of such artifacts. Standard algorithms (such as described e.g. in R. M. Lewitt, “Processing of incomplete measurement data in computed tomography”, Med. Phys., vol. 6, no. 5, pp. 412-417, 1979) require the estimation of an object boundary or a projection extension factor.

U.S. Pat. No. 6,256,367 B1 discloses a method of correcting aberrations caused by target x-ray scatter in three-dimensional images generated by a volumetric computed tomographic system. The method uses a Monte-Carlo simulation to determine the distribution of scattered radiation reaching the detector plane. The geometry for the scatter calculation is determined using the uncorrected three-dimensional tomographic image. The calculated scatter is used to correct the primary projection data which is then processed routinely to provide the corrected image.

It is an object of the present invention to provide an apparatus and a corresponding method for artifact correction of a data set of x-ray projections of an object, in particular for correction of artifacts caused by scatter or a truncation of x-ray projections, which requires less computational effort and which thus allows a correction in real-time. It is a further object to provide an apparatus and a corresponding method for generating a reconstruction image from a data set of x-ray projections of an object including less or no artifacts.

The object is achieved according to the present invention by an apparatus for scatter correction as claimed in claim 1, comprising:

a model estimation unit for estimating model parameters of an object model for said object by an iterative optimization of a deviation of forward projections, calculated by use of said object model and the geometry parameters for said x-ray projections, from the corresponding x-ray projections,

a scatter estimation unit for estimating the amount of scatter present in said x-ray projections by use of said object model, and

a correction unit for correcting said x-ray projections by subtracting the estimated amount of scatter from said x-ray projections for determining an optimized object model using said corrected x-ray projections, said optimized object model being used in another iteration of said scatter correction, said scatter correction being iteratively carried out until a predetermined stop criterion has been reached.

The invention is based on the idea to base the scatter estimation on a simple, parametric object model, in particular a 3D object model, collectively determined from a representative set of acquired projections. In general, the model should fit extension, shape, position, orientation, absorption and scattering properties of the imaged object as good as possible. However, because objects of not too different shape and density usually still produce a similar amount of scatter, and because slightly falsified scatter estimates usually still allow for compensation of scatter caused image artifacts to a relatively wide extent, approximate conformance between model and imaged object may be sufficient.

For instance, as will be described hereinafter below as an example, a homogeneous ellipsoid model with water-like scatter characteristics can be used. The geometric shape of the ellipsoid is assumed of being able to approximately model the shape of a human head, possibly including the neck. The ellipsoid model is determined by a total of 10 model parameters, 3 of them specifying the position of the ellipsoids center of mass, 3 specifying the extents of the ellipsoid half axes, 3 specifying rotation angles that define the orientation of these axes in three-dimensional space, and the remaining one specifying the x-ray absorption of the homogeneous ellipsoid relative to water. Depending on the desired clinical application, also different and more sophisticated object models may be considered.

Based on the estimated parametric model, the corresponding scatter constants for each projection or alternatively, the corresponding scatter fraction values (the fraction of scattered radiation with respect to the total detected photon energy, composed of contributions from primary and scattered radiation) are then estimated, preferably by means of probabilistic Monte-Carlo simulations as proposed according to an embodiment of the invention. For realistic, voxelized objects and if the spatial distribution of scattered radiation in each projection is desired, such simulations are far too time consuming to be performed in real time, even with fast computers. However, for a simple and homogeneous geometric object model and using forced detection techniques, a sufficiently accurate estimate of the average scatter level in the object shadow in one projection or the scatter contribution at a single detector pixel in several projections can be computed in a few seconds or even in real-time.

As an alternative to online calculations, to further improve speed of the correction procedure, it is proposed according to another embodiment to compute the scatter values for all possible combinations of model parameters offline and to store the results in a scatter look-up table used for determining the amount of scatter in the x-ray projections based on the actual model parameters.

The proposed method for a posteriori scatter correction thus aims at estimating the level and possibly the shape of the scatter distribution in each acquired x-ray projection. After estimation, the estimated scatter is subtracted from the detector counts at each detector pixel, and a scatter-compensated 3D image can be reconstructed from the corrected projections. As will be explained below in more detail, already subtraction of a spatially uniform scatter level that changes from one projection to another can compensate scatter-caused inhomogeneities in the reconstructed image to a wide extent, provided that the estimated constants are sufficiently accurate.

The proposed optimization procedure can be fully automated, not requiring any user interaction. To increase accuracy of the scatter correction procedure, it can be performed multiple times in a row in an iterative fashion. As a stop criterion for said iteration a predetermined number of iterations, a predetermined minimum value for the difference of said estimated amount of scatter from said x-ray projections in subsequent iterations or a predetermined minimum value for the difference of model parameters obtained in subsequent iterations can be used.

The general idea of the present invention, although mainly proposed for improvement of scatter correction, is not limited to that application. Alternatively, it can instead be used to optimize performance of truncation correction. Truncations of x-ray projections cause spatially slowly varying inhomogenities in a reconstruction image, too. The object is thus also achieved according to the present invention by an apparatus for extension of truncated x-ray projections as claimed in claim 7, comprising:

a model estimation unit for estimating model parameters of an object model for said object by an iterative optimization of a deviation of forward projections, calculated by use of said object model and the geometry parameters for said x-ray projections, from the corresponding x-ray projections,

a truncation estimation unit for estimating the degree of truncations present in said x-ray projections by use of said object model, and

a correction unit for correcting said x-ray projections by extending said x-ray projections using said estimated degree of truncations.

Preferably, extension of the truncated projections is done using an extension scheme similar as the one described in the above mentioned article of R M. Lewitt, but with a different extension factor for each projection and each detector side to guarantee accurate handling of rotationally non-symmetric objects and off-center positioning. For this purpose, each projection is preferably assigned two extension factors, representing the ratio of the lateral extent of the object model to the lateral extent of the truncated projection in the left and right detector parts. Then, each row of each projection is extended by fitting elliptical arcs with the previously determined lateral extents to both of its ends.

A reconstruction apparatus according to the invention is defined in claim 16 comprising:

an image acquisition unit for acquiring said data set of x-ray projections of an object,

an apparatus as claimed in claim 1 for scatter correction of said data set of x-ray projections and/or an apparatus as claimed in claim 7 for extension of truncated x-ray projections of a data set of x-ray projections, and

a high resolution reconstruction unit for generating a high resolution reconstruction image of said object from said corrected and/or extended x-ray projections.

Corresponding methods are defined in claims 14, 15 and 17. The invention relates also to a computer program which may be stored on a record carrier as defined in claim 18.

The invention will now be explained in more detail by use of exemplary embodiments illustrated in the accompanying drawings in which

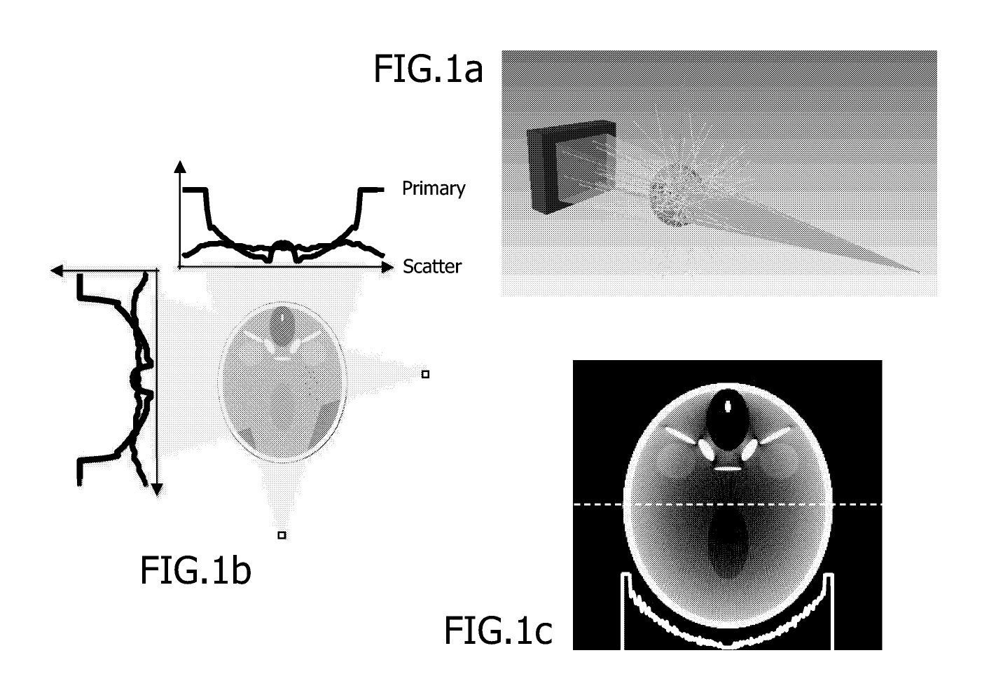

FIG. 1 illustrates the impact of scatter,

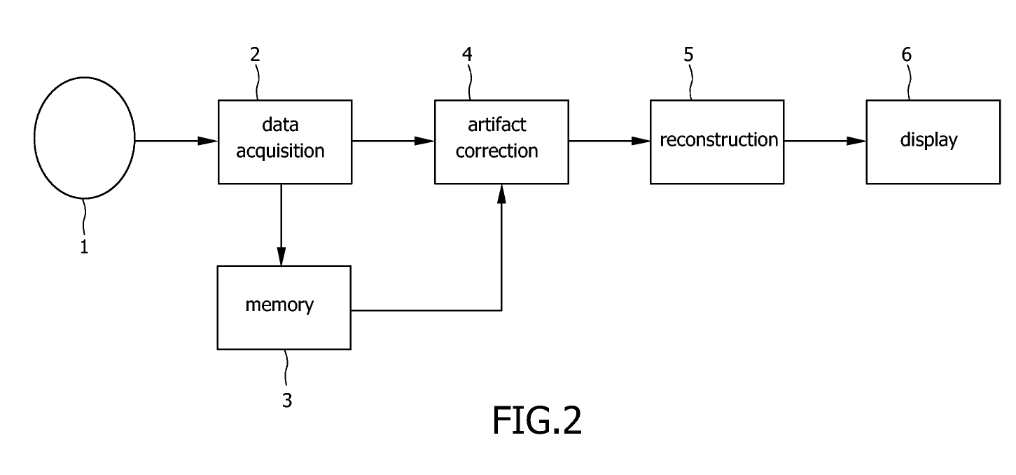

FIG. 2 shows a block diagram of a reconstruction apparatus according to the present invention,

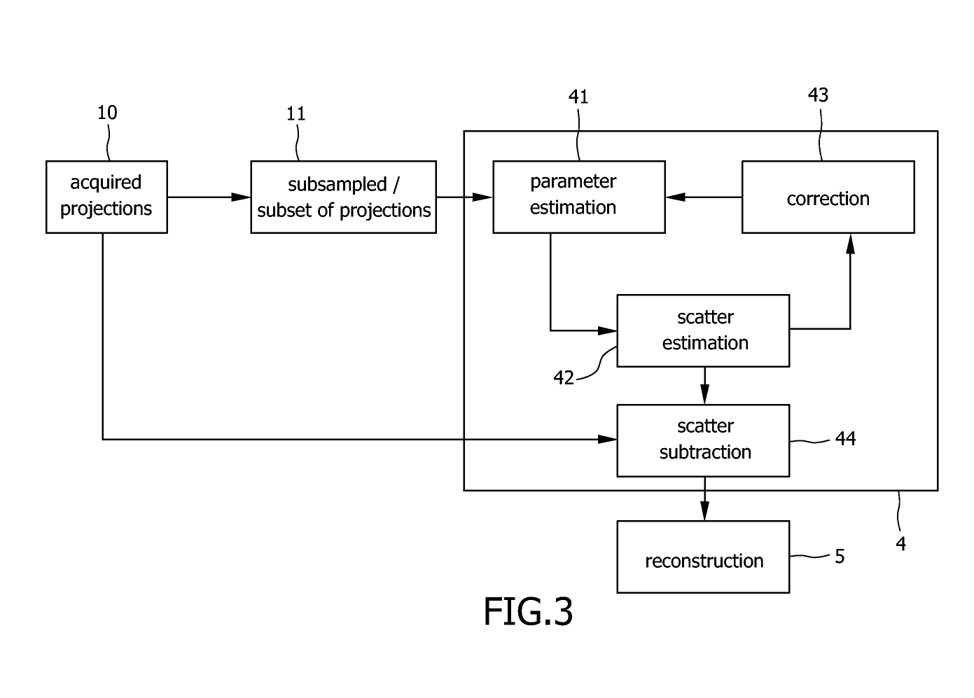

FIG. 3 schematically illustrates a scatter correction apparatus according to the present invention,

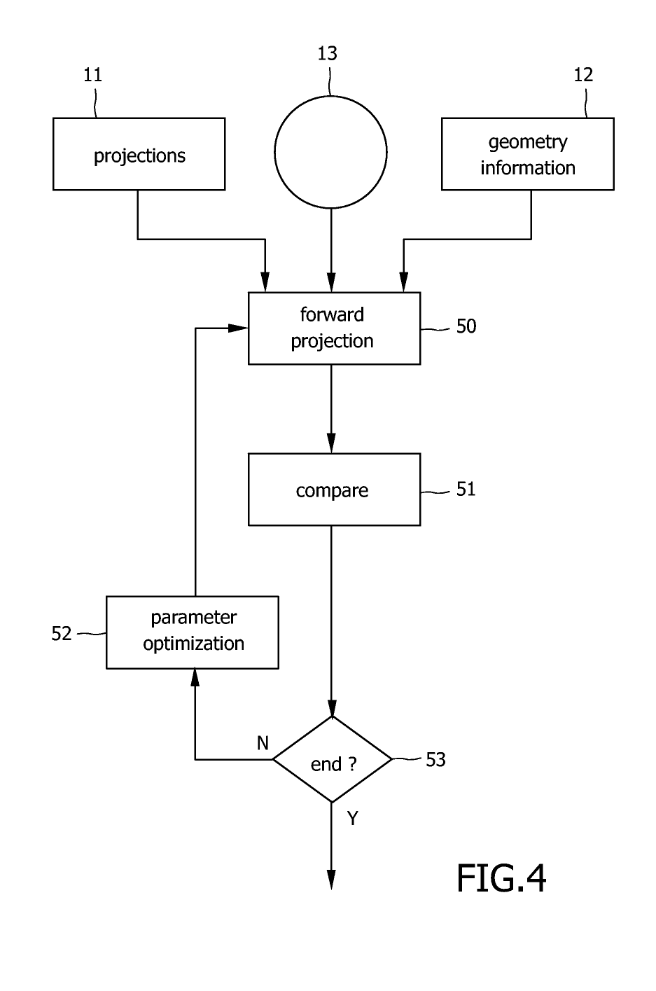

FIG. 4 shows a flow chart of the steps proposed for estimating model parameters according to the present invention,

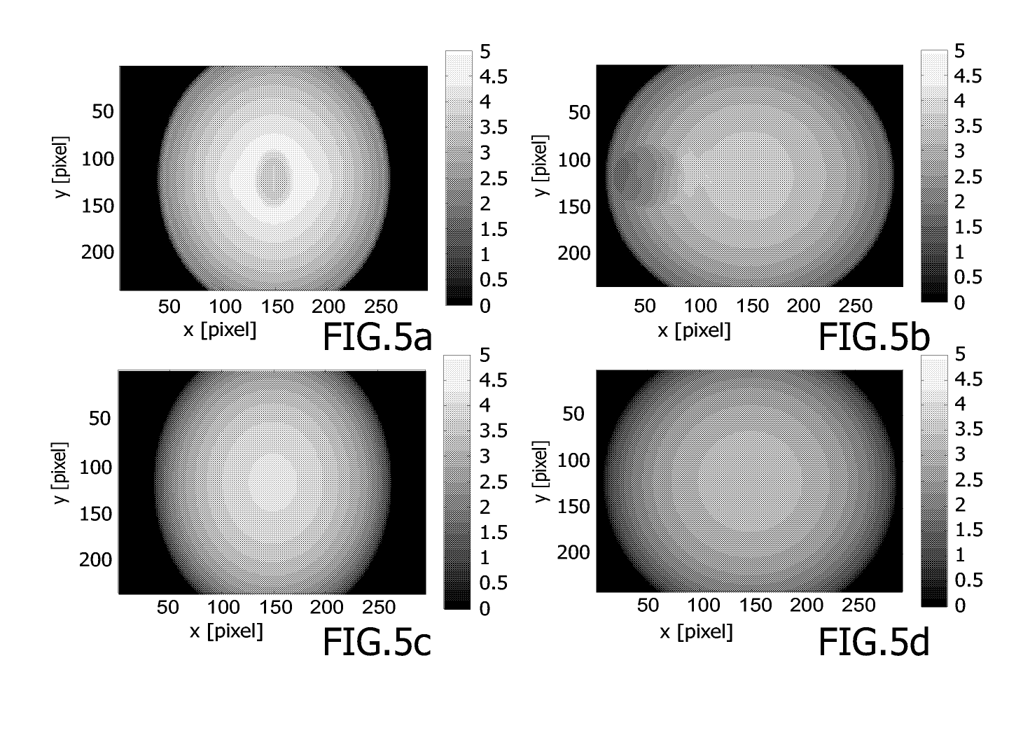

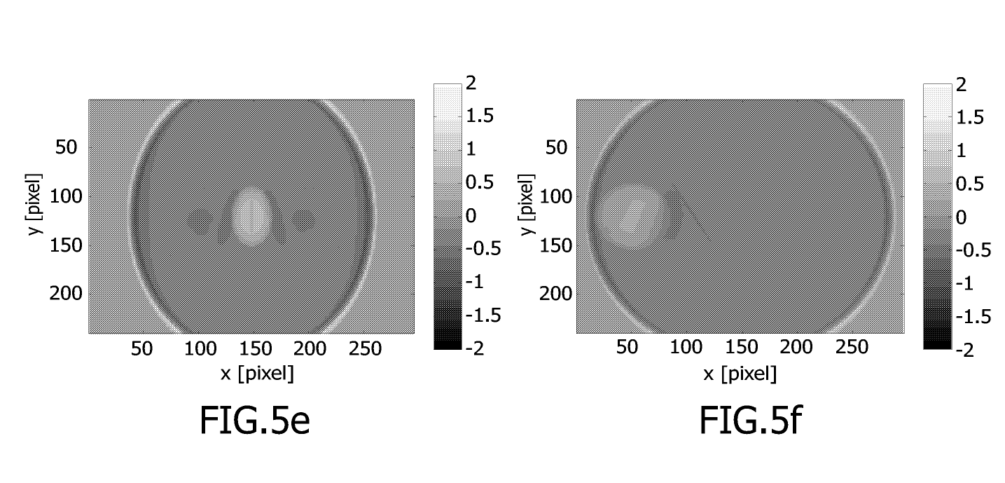

FIG. 5 illustrates optimization results achieved by use of the present invention,

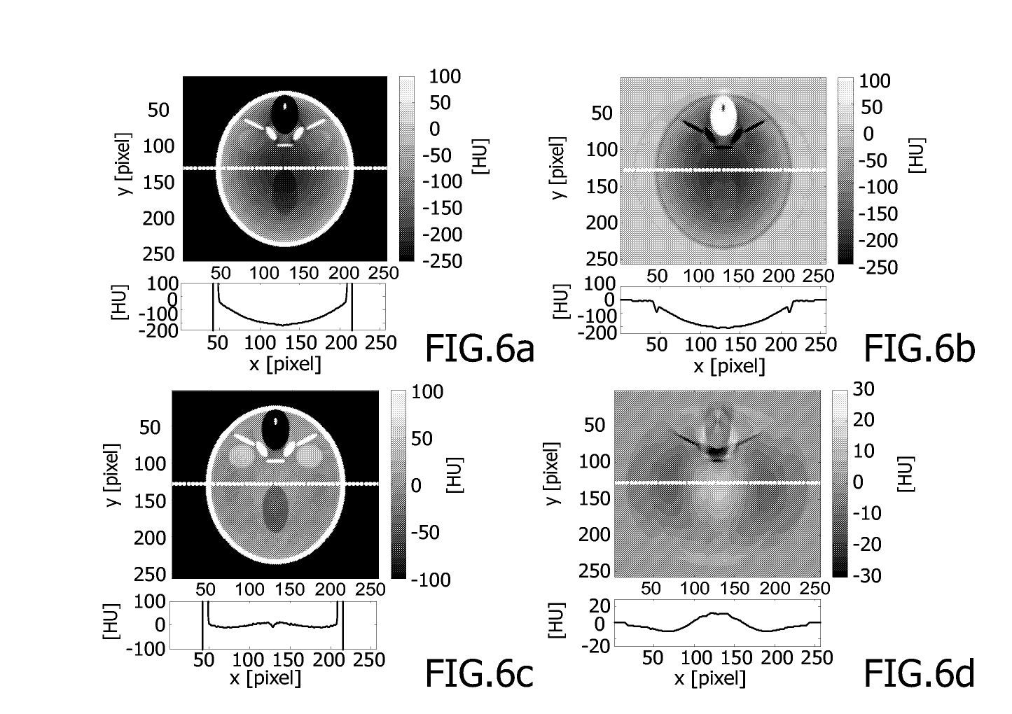

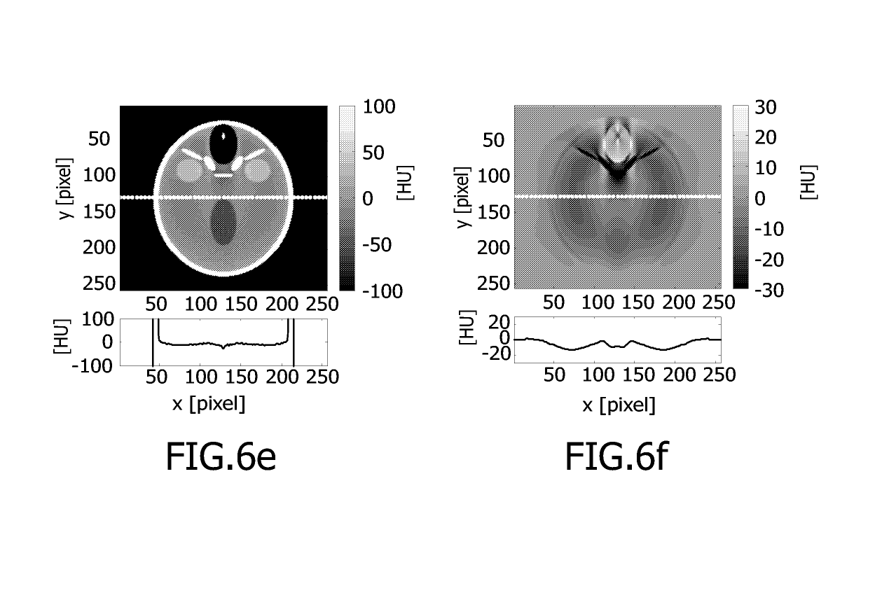

FIG. 6 shows reconstructions of a head phantom obtained by use of the present invention, and

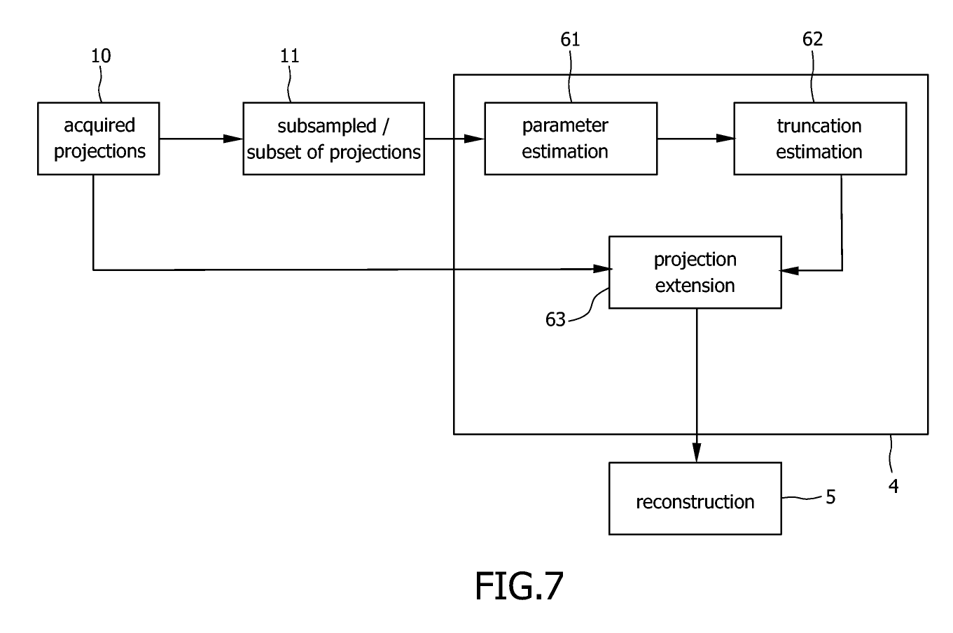

FIG. 7 schematically illustrates a truncation extension apparatus according to the present invention.

Before the invention will be explained in more detail by way of embodiments the impact of scatter and the generation of cupping artifacts caused by scattered radiation shall be illustrated by way of FIG. 1. While the theory of computed tomography (CT) reconstruction assumes that all photons are either absorbed in an examined object or reach the detector directly, the largest amount of attenuation is, in fact, not caused by absorption but scatter. Therefore, a considerable amount of scattered photons reaches the detector on a non-straight way as can be seen in FIG. 1a.

As shown in FIG. 1b the background signal caused by scattered radiation is generally relatively homogeneous, i.e. especially slowly varying, but its amount is particularly significant. The portion of the total signal intensity caused by scattered radiation can—without anti-scatter grids—amount up to 50% or more. As can be seen from the profiles shown in FIG. 1b the relative error is largest for the total signal in the middle of the attenuation signal. Consequently, the relative error is also largest in the middle of the reconstructed object as shown in FIG. 1c where at the bottom the typical effect of cupping can be seen. For instance, for the head deviations up to −150 HU below the correct grey value can be found.

Thus, the problems caused by scatter induced artifacts are that scatter impedes the absolute quantification (HU), affects the visibility of low contrast structures and creates problems for further image processing.

FIG. 2 schematically shows the general layout of a reconstruction apparatus according to the present invention. By use of a data acquisition unit 2, for instance a CT or X-ray device, a data set of X-ray projections of an object 1, i.e. a patient's head, is acquired. The acquired data set is generally stored in a memory such as a hard disc of a server in a clinical network or another kind of storage unit of the work station further processing the acquired projection data. Before high-resolution reconstruction images are generated by a reconstruction unit 5 it is foreseen according to the present invention that an artifact correction is carried out by use of an artifact correction apparatus 4 which will be explained in more detail below. The corrected X-ray projections are then used for reconstructing a high resolution reconstruction image for subsequent display on a display unit 6.

FIG. 3 schematically illustrates the layout and the function of scatter correction apparatus for a posteriori scatter correction as proposed according to the present invention. In this figure more details of the artifact correction unit 4 shown in FIG. 2 will be illustrated by way of a non-limiting example.

Following the rotational acquisition of a sequence of projections 10, a number of, for instance, about 10-40 pre-processed images 11 in approximately constant viewing angle distance is selected for the scatter estimation process. Such angular down-sampling strongly decreases computational effort of the method but still provides sufficiently accurate results as long as the angular distances between the projections are not too large, since the simple model can still be fitted sufficiently exact with a reduced number of projections and the scatter level is a slowly varying function of the viewing angle.

The heart of the proposed method is represented by an iterative loop trough a three-step procedure:

a) estimation of the model parameters by use of a model estimation unit 41;
b) scatter estimation from online Monte-Carlo simulations or table look-up by use of a scatter estimation unit 42; and
c) correction of the projections using the scatter estimate by use of a correction unit 43. Purpose of the iteration is to stepwise increase the accuracy of the model estimate, since projection-based estimation of the optimal set of model parameters in turn requires availability of scatter-free projections. It will be demonstrated below that this three-step sequence shows sufficient convergence usually after a maximum of three iterations, i.e., the model parameters and therefore the scatter estimate change only marginally after the third iteration.

Finally, after convergence has been reached or after a predetermined number of iterations, the final sequence of estimated scatter values for each projection is up-sampled using standard interpolation techniques, e.g., cubic interpolation. In this way, a scatter constant estimate is obtained for the complete set of acquired projection data which is then subtracted from the original, acquired projections 10 in a subtraction unit 44 which is functionally identical to the correction unit 43, but uses as input the acquired projections 10 instead of the subsampled projections 11. In practice, however, the same unit can be used for performing the function of units 43 and 44. From the finally corrected projections the desired image can be reconstructed by reconstruction unit 5.

With reference to FIG. 4 the estimation of the model parameters from a number of acquired projections performed by scatter estimation unit 41 is described in more detail. This task is achieved by means of an iterative optimization procedure. The procedure requires access to the full acquisition geometry information 12 (detector size, position and orientation, focus position) for each utilized projection 11. Further, a start model 13, which should approximately model the shape of the object under examination, is used in the initial run of the iteration. Here, as an example, an ellipsoid model shall be considered that models the shape of a human head.

Using the geometry information 12, the model parameters are determined in such a way that there is maximum correspondence between the line integrals in the measured projections and the corresponding line integrals obtained by forward projecting the ellipsoid model. Here, maximum correspondence is defined in the sense of least mean square deviation between the line integrals of the object and of the model. First, in step 50, forward projections of the model are analytically calculated using the same geometry as was utilized in the object scan. To save computation time, mono-energetic radiation is assumed for the forward projections. In a second step 51 the calculated forward projections are compared to the corresponding actual projection (from the data set 11), i.e. the deviation of the calculated forward projection from the corresponding actual projection is determined. Finally, it is checked in step 53 if further iterations shall be performed, in that case using model parameters that are updated in a subsequent step 52 based on the determined deviations, or if the last model parameters shall be used for next steps of the correction method. Different stop criteria can thereby be used, e.g. a predetermined number of iterations or a threshold for the determined deviations, or a threshold for the change of updated model parameters.

Expressing this situation mathematically, the set of model parameters p that minimize the cost function

$$f ( p ) = {\sum }_{θ} {\sum }_{N} {( {P}_{θ , N} ( M ( p ) ) - {P}_{θ , N} ( O ) )}^{2}$$

shall be determined. Here, P_{θ,N} denotes the line integral of detector pixel N in projection θ, M is the ellipsoid model, and O is the imaged object. Starting from an initial guess (the start model 13), iterative optimization of the model parameters can be achieved using standard algorithms for constrained non-linear optimization. A number of optimization algorithms that can be used for this purpose are, for instance, described in W. H. Press, S. A. Teukolsky, W. T. Vetterling, B. P. Flannery, Numerical Recipes in C, 2^{nd} ed. Cambridge University Press, 1992. Obvious constraints are positive values for the ellipsoid half axes and for the attenuation factor relative to water. In an implementation, optimization is performed using a trust-region reflective Newton algorithm provided by the MATLAB optimization toolbox.

For computational efficiency, only a subset of on the order of 100 detector pixels per sample projection is utilized in Eq. (1). The accuracy of estimated parameters is further improved by using a different pixel subset in each of the roughly 30 sample projections. Using the MATLAB algorithm, parameter optimization was found to be robust and typically converged in about 5 seconds on a 2.4 GHz CPU. Furthermore, using the previously determined model parameters as initial guess strongly reduces the computational demand of the optimization procedure in a second and third cycle of the scatter correction loop sketched in FIG. 3.

Following the estimation of model parameters, the scatter levels or fractions for each sample projection will be estimated from Monte-Carlo (MC) simulations. As mentioned above, MC simulations may either be conducted online, or the results of multiple simulations may be stored in a look-up table. Both methods shall now be explained in more detail.

First, the use of online MC simulations shall be described. For fast calculation of the scatter level in a projection, a forced detection technique can be utilized. With forced detection, scatter contributions to all simulated detector cells are calculated after each scattering event. This framework treats both Rayleigh and Compton scattering in a probabilistic way, while photo absorption is accounted for analytically via accordingly reduced contributions. As compared to fully probabilistic Monte-Carlo simulations, this technique yields smooth scatter distributions even at very low photon numbers, but increases computation time per photon. It can be used advantageously if only a sparse sampling of the scatter distribution or a single scatter estimate per projection is required.

Using this technique, online simulation of the scatter and primary energy at a single (or very few) detector cells is feasible for a single, homogeneous mathematical object such as the model ellipsoid. On a 2.4 GHz CPU, simulations of a single central detector cell require a computation time of about 5-10 s for an entire sweep comprised of 36 projections, yielding satisfactory accuracy with statistical fluctuations of only few percent.

Following the computation of detected scatter and primary energy at one or few detector pixels in the center of the object shadow, the results are normalized by the value for unattenuated primary radiation. Two alternatives exist for the subsequent scatter correction procedure. For correction of absolute scatter in a projection, the normalized simulated scatter constant of the ellipsoid (or the average scatter value within a projection) is directly subtracted from the normalized detected values at each detector cell. For a fractional correction, the scatter fraction SF=S/(S+P) of the ellipsoid is first calculated using the normalized simulated values of scatter energy S and primary energy P. Then, the estimated scatter value SF×Dₘᵢₙ, where Dₘᵢₙ denotes the minimum detected value in the considered acquired projection, is subtracted from the normalized detected values at each detector cell. To minimize effects of noise and influence of localized structures with high attenuation, the value of Dₘᵢₙ should be determined in a regularized way by first applying strong spatial low-pass filtering to the acquired projections.

As an alternative to online simulations, another option is to conduct extensive Monte-Carlo simulations offline for a large number of combinations of the model parameters (10 parameters in the example considered here) and to store the results in a look-up table. Main advantages of this approach are a comparably low implementation effort and a potential speed-up of the correction procedure. However, this approach is less flexible since settings such as geometrical system setup, tube spectrum, beam filter characteristics, beam collimation, use of a beam-shaping device, and use of an anti-scatter grid must either be fixed a priori or separate look-up tables must be constructed for all possible combinations of such settings.

Before table look-up, for each acquired sample projection the ellipsoid offset vector and rotation angles are transformed into a detector coordinate system using the geometry data of the scan. Then, the corresponding scatter and primary energy values are obtained from the table by means of 10-fold parameter interpolation. For optimal results, the interpolation of primary energy should be conducted in the domain of attenuation line integrals, i.e., after logarithmizing the corresponding table entries in the domain of normalized detector counts. Application of the method is illustrated in FIGS. 5 and 6 using a set of simulated cone-beam projection data of a mathematical head phantom consisting of different geometric objects.

Estimation of the model ellipsoid parameters was undertaken according to the proposed method. The optimization result is shown in FIG. 5, displaying two perpendicular projections of the head phantom (top), two corresponding forward-projections of the estimated model (middle), as well as the respective difference images (bottom).

Following the determination of the model parameters, estimates for the average scatter level as well as the scatter fraction in each projection were obtained using a look-up table approach as explained above. The resulting scatter estimates were then subtracted from the sample projections, and the procedure of model estimation, scatter estimation, and scatter correction was repeated three times.

To improve accuracy of the model-based method, a constant compensation factor c may be introduced that compensates for systematic deviations between model and object, e.g., compensates for additional absorption of the calotte of a head (the compensation is applied by multiplying each determined scatter value by this factor). The magnitude of the compensation factor may depend on the imaged object. Thus, in this example, compensation factors of c=0.84 and c=0.90 were used for absolute and relative correction, respectively.

Finally, reconstructions of the simulated head phantom are shown in FIG. 6. The left column displays slices reconstructed using uncorrected and differently corrected projections, while the right column shows corresponding difference images to a scatter-free reconstruction. Examining the uncorrected images in the top of FIG. 6, it can be found that scatter induces strong low-frequency inhomogeneity (cupping artifact) that in the central horizontal cross section of the shown slice amounts to more than 200 HU. Applying absolute (middle row in FIG. 6) and fractional (bottom row in FIG. 6) model-based correction strongly reduces cupping/capping to remaining variations of about 20 HU (it should be noted that a different gray value scale is used for the uncorrected images). This clearly demonstrates the high potential of the model-based scatter correction approach for applications in neuro imaging.

While the invention is mainly applied for scatter correction, other applications of the general idea of the invention are possible. For instance, the invention can be applied for extension of truncated projections or for determination of an extension factor for such an extension. FIG. 7 schematically illustrates the layout and the function of a projection extension apparatus for a posteriori projection extension as proposed according to the present invention.

The proposed method for projection extension uses essentially the same steps as described above with reference to FIG. 3. The model estimation unit 61 is identical to unit 41. Further, a truncation estimation unit 62 is provided for estimating the degree of truncations present in the examined x-ray projections by use of the object model having the model parameters determined by unit 61. Still further, a correction unit 63 is provided for correcting the x-ray projections by extending said x-ray projections using the estimated degree of truncations.

Preferably, the degree of truncations is estimated in unit 62 by determining the spatial extent of a non-truncated forward projection of the estimated object model and comparing this extent to the spatial extent of said x-ray projections. Further, the x-ray projections are extended in unit 63 by smooth continuation of said x-ray projections using estimated extension factors or estimated object boundaries estimated by making use of said truncation estimate.

In an implementation, a truncated projection is extended by using forward projections of a modification of the estimated model. The modification is such that the estimated attenuation value of the model is replaced by the value that results in maximal correspondence between the forward projection and the acquired projection near the truncation boundary. This guarantees smooth continuation of the extended projection and is based on the assumption that the estimated object boundary coincides with the boundary of the model. In another implementation, similar results are obtained by fitting elliptical arcs with the previously determined lateral extents to both ends of each row of a truncated projection.

Briefly summarized, the invention proposes a relatively simple but accurate method for scatter correction and/or projection extension. Projection-based estimation of a geometrical model is involved, and the method does not require iterative reconstructions.

The basic idea is to estimate the parameters of a geometrical model solely from the measured projections, and to use this model for estimations of the scatter level and the degree of truncation separately in each projection. For estimation of the model parameters, employment of a numerical optimization scheme to minimize the mean square deviation from the projection values is suggested.

The used geometrical models are suggested to be simple and to consist of only one or few homogeneous ellipsoidal or cylindrical objects. Because the scatter distribution is a spatially slowly varying function and because the truncated region itself is not reconstructed, the model must only roughly approximate the shape of the object to allow for sufficiently accurate scatter correction and truncation artifact prevention.

Using the parametric model, the scatter level in each projection is either directly determined using Monte-Carlo simulations, or it is interpolated using a look-up table previously constructed by means of such simulations. The estimated scatter is then subtracted from each projection. For accurate projection extension, it is suggested to use the model to derive the degree of lateral truncation separately for each projection and for both detector sides, and to fit an elliptical arc with according lateral extent to each projection end.

Application of the suggested strategies for scatter correction and truncation artifact prevention in C-arm X-ray volume imaging is expected to significantly reduce cupping and capping artifacts due to scatter and truncations in a relatively simple but robust way. In this way, the methods improve low contrast visibility and therefore contribute towards overcoming the current restriction of C-arm based X-ray volume imaging to high contrast objects, a goal which is supposed to open new areas of application for diagnosis as well as treatment guidance. The strategy for scatter correction may also be of value for spiral CT as cone angles are becoming larger.

1. Apparatus for iterative scatter correction of a data set of x-ray projections (10) of an object (1) for generation of a reconstruction image of said object, comprising:
a model estimation unit (41) for estimating model parameters of an object model for said object by an iterative optimization of a deviation of forward projections, calculated by use of said object model and the geometry parameters for said x-ray projections, from the corresponding x-ray projections,
a scatter estimation unit (42) for estimating the amount of scatter present in said x-ray projections by use of said object model, and
a correction unit (43) for correcting said x-ray projections by subtracting the estimated amount of scatter from said x-ray projections for determining an optimized object model using said corrected x-ray projections, said optimized object model being used in another iteration of said scatter correction, said scatter correction being iteratively carried out until a predetermined stop criterion has been reached.

2. Apparatus as claimed in claim 1, wherein said model estimation unit (41) is adapted for determining optimized model parameters of a model using scatter-corrected projections determined in a previous iteration of said scatter correction.

3. Apparatus as claimed in claim 1, wherein said scatter estimation unit (42) is adapted for estimating the amount of scatter present in said x-ray projections by use of Monte-Carlo simulations.

4. Apparatus as claimed in claim 3, wherein said scatter estimation unit (42) is adapted for carrying out online Monte-Carlo simulations using a forced detection method for determination of the amount of scatter in said x-ray projections.

5. Apparatus as claimed in claim 3, wherein said scatter estimation unit (42) is adapted for estimating the amount of scatter by use of a look-up table containing the amount of scatter for different values of model parameters.

6. Apparatus as claimed in claim 1, wherein said stop criterion is a predetermined number of iterations, a predetermined minimum value for the difference of said estimated amount of scatter from said x-ray projections in subsequent iterations or a predetermined minimum value for the difference of model parameters obtained in subsequent iterations.

7. Apparatus for extension of truncated x-ray projections of a data set of x-ray projections (10) of an object (1) for generation of a reconstruction image of said object, comprising:
a model estimation unit (61) for estimating model parameters of an object model for said object by an iterative optimization of a deviation of forward projections, calculated by use of said object model and the geometry parameters for said x-ray projections, from the corresponding x-ray projections,
a truncation estimation unit (62) for estimating the degree of truncations present in said x-ray projections by use of said object model, and
a correction unit (63) for correcting said x-ray projections by extending said x-ray projections using said estimated degree of truncations.

8. Apparatus as claimed in claim 7, wherein said truncation estimation unit (62) is adapted for estimating the degree of truncations by determining the spatial extent of a non-truncated forward projection of the estimated object model and comparing this extent to the spatial extent of said x-ray projections.

9. Apparatus as claimed in claim 7, wherein said correction unit (63) is adapted for extending said x-ray projections by smooth continuation of said x-ray projections using estimated extension factors or estimated object boundaries estimated by making use of said truncation estimate.

10. Apparatus as claimed in claim 1, wherein said model estimation unit (41; 61) is adapted for estimating said model parameters of said object model by iteratively minimizing a least mean square deviation of forward projections from the corresponding x-ray projections.

11. Apparatus as claimed in claim 1, wherein said model parameters comprise geometric parameters of said object model, in particular parameters defining the location, orientation and/or size of said object model.

12. Apparatus as claimed in claim 1, wherein said model parameters comprise at least one attenuation parameter defining the x-ray attenuation of said object model.

13. Apparatus as claimed in claim 1, wherein said model estimation unit (41; 61) is adapted for using only a subset of the available detector pixels of an x-ray projection for said estimation, wherein a different subset is used for different x-ray projections.

14. Method for iterative scatter correction of a data set of x-ray projections (10) of an object (1) for generation of a reconstruction image of said object, comprising the steps of:
estimating model parameters of an object model for said object by an iterative optimization of a deviation of forward projections, calculated by use of said object model and the geometry parameters for said x-ray projections, from the corresponding x-ray projections,
estimating the amount of scatter present in said x-ray projections by use of said object model,
correcting said x-ray projections by subtracting the estimated amount of scatter from said x-ray projections for determining an optimized object model using said corrected x-ray projections, said optimized object model being used in another iteration of said scatter correction, said scatter correction being iteratively carried out until a predetermined stop criterion has been reached.

15. Method for extension of truncated x-ray projections of a data set of x-ray projections (10) of an object (1) for generation of a reconstruction image of said object, comprising the steps of:
estimating model parameters of an object model for said object by an iterative optimization of a deviation of forward projections, calculated by use of said object model and the geometry parameters for said x-ray projections, from the corresponding x-ray projections,
estimating the degree of truncations present in said x-ray projections by use of said object model, and
correcting said x-ray projections by extending said x-ray projections using said estimated degree of truncations.

16. Reconstruction apparatus for generating a reconstruction image from a data set of x-ray projections of an object, comprising:
an image acquisition unit (2) for acquiring said data set of x-ray projections of an object,
an apparatus (4) as claimed in claim 1 for scatter correction of said data set of x-ray projections (10) for extension of truncated x-ray projections of a data set of x-ray projections (10), and
a high resolution reconstruction unit (5) for generating a high resolution reconstruction image of said object from said corrected and/or extended x-ray projections.

17. Reconstruction method for generating a reconstruction image from a data set of x-ray projections of an object, comprising the steps of:
acquiring said data set of x-ray projections of an object,
scatter correction of said data set of x-ray projections (10) as claimed in claim 14, and
generating a high resolution reconstruction image of said object from said corrected and/or extended x-ray projections.

18. Computer program comprising program code means for causing a computer to carry out the steps of the method as claimed in claim 14 when said computer program is executed on a computer.
